(19) United States
(12) Patent Application Publication
(10) Pub. No.: US 2008/0098704 A1
(43) Pub. Date: May 1, 2008

(54) Plant clearing-grinding device

(75) Inventors: Michel Maurice Dairon, Pruille L'Eguille (FR); Jose Alain Loyer, Mansigne (FR)

Correspondence Address: LEYDIG VOIT & MAYER, LTD, 700 THIRTEENTH ST. NW, SUITE 300, WASHINGTON, DC, 20005-3960, US

(73) Assignee: SAS DAIRON, Mulsanne (FR)

(21) Appl. No.: 11/927,750

(22) Filed: Oct. 30, 2007

(30) Foreign Application Priority Data
Oct. 31, 2006 (FR) 0654660

(51) Int. Cl. A01D 69/03; A01D 34/412

(52) U.S. Cl. 56/11.9; 56/13.5

(57) ABSTRACT

A plant clearing-grinding device has a front deflector inclined upward and bending plants during movements of the device, the front edge of deflector having two separate curved parts with radii centered respectively on two vertical axes of rotation of two rotors with blades so that the plants contacting each curved part penetrate into a zone of action of the blades.

The present invention relates to a plant clearing-grinding device.

Such a device is generally coupled to a tractor vehicle for moving it in order to ensure cutting and grinding of plants consisting particularly of small shrubs.

This device is applied particularly as a forestry grinder.

Plant grinding devices known up to now have a casing that is open underneath, and a rotor put in rotation by a motorized means around a vertical axis and having a plate equipped with cutting and grinding blades under the casing.

The casing, in its front part, has an opening for entry of the plants to be cut and ground, and in its rear part, has an opening for evacuation of the cut and ground plants.

These known devices have the major disadvantages that certain plants approaching the entrance opening of the casing, particularly those situated on the sides of this opening, are situated outside the zone of action of the rotating blades and consequently escape the cutting and grinding operations. Furthermore, when the plants consist of small shrubs, the tractor vehicle must exert on the casing, which generally rests on the ground by lateral skids, an extremely great force of forward movement in order to make the shrubs penetrate into the grinding zone of the rotating blades. Now, this force tends to raise the casing of the grinding device, and the rotating blades have difficulty attacking the low parts of small shrubs, in that case leading to a poor quality of the grinding of the shrubs.

The present invention aims to remedy the above disadvantages of the known clearing-grinding devices.

To this effect, according to the invention, the plant clearing-grinding device having a casing that is open underneath and capable of being coupled to a tractor vehicle, and at least one motorized rotor mounted so as to rotate around a vertical axis under the casing and having a plate equipped with cutting and grinding blades, the casing having in its front part an opening for entry of the plants to be cut and ground and in its rear part an opening for evacuation of the cut and ground plants, is characterized by the fact that it has two motorized rotors mounted so as to rotate respectively around two vertical axes under the casing with each having a plate equipped with cutting and grinding blades, by the fact that the front part of the casing has a fixed external deflector inclined upward above the opening for entry of the plants so that these plants are bent at their low parts by the deflector during movement of the device so as to facilitate their penetration into the entrance opening and their cutting and grinding by the blades, and by the fact that the front edge of the deflector has two separate curved parts in the transverse direction with respect to the direction of movement of the device and whose radii are respectively centered on the two vertical axes of rotation of the rotors in such a way that the plants contacting each curved part can penetrate into the zone of action of the blades of the corresponding rotor.

The device has a rigid bow whose arms are mounted so as to pivot on the casing according to an axis that is transverse with respect to the direction of movement of the device in opposition to the force of return of elastic means of the bow to a lowered position, and the central bar can rest, during movement of the device, on high parts of plants in order to raise it in opposition to the force of return of the elastic means and to exert a bending force on the plants before they are contacted by the deflector in order to facilitate their entry into the zone of action of the blades.

Preferably, the elastic return means includes two helical draw springs, each of which is attached between the casing and the corresponding arm of the bow.

Advantageously, each draw spring is housed in a protective sheath.

The blades of each rotor are attached in a removable manner to the ends of essentially radial arms of the corresponding plate and include flat blades respectively attached under the support arms.

The blades also include vertical blades respectively attached on the radial arms.

The support arms for the blades at each of their ends have a ballast.

Each vertical blade is attached to the corresponding ballast.

Each horizontal blade has the general shape of an equilateral triangle whose sharp sides are exteriorly convex and is attached to the end of the corresponding support arm in such a way that only one summit of the blade delimited by two sharp sides projects from the arm.

Each horizontal blade can be disconnected from its support arm and re-attached to this arm in such a way that one of the other two summits of the blade projects from the arm.

Advantageously, the horizontal blades of the two rotors are situated in the same cutting plane.

The vertical axes of the two rotors are a distance apart from one another transversely in such a way that the zones of action of their respective horizontal and vertical blades overlap.

The casing is coupled to the tractor vehicle in such a way that it can pivot according to a limited angle around a horizontal axis that is transverse with respect to the direction of forward movement of the vehicle as a function of the irregularities of the ground.

The casing is coupled to the tractor vehicle by the intermediary of a rigid frame attached in a removable manner on one side to a lifting structure belonging to the tractor vehicle and attached on the opposite side to two vertical walls of the casing forming a support flange for the ends in the form of journals of a shaft of the frame extending transversely with respect to the direction of forward movement of the tractor vehicle.

The frame is attached to a plate of the lifting structure of the tractor vehicle, the plate being attached in a removable manner in a bracket connected to the frame.

The frame is housed in a recumbent part approximately in the shape of a truncated pyramid of the casing, the two walls, upper and lower, of the recumbent part being inclined with respect to one another in such a way as to delimit between them the angular clearance of the casing relative to the frame around the horizontal axis of pivoting of the casing.

Advantageously, the maximum angle of pivoting of the casing is approximately 10°.

The vertical axes of the two rotors are offset with respect to one another according to the direction of movement of the device.

The casing rests on the ground by the intermediary of skids connected to the lateral walls of the casing.

A protective overturned cup is attached under the plate of each rotor and below the blades borne by the plate while being mounted free to rotate at the rotating plate coaxially with respect to the vertical axis of the rotor.

Each rotor is driven directly by a hydraulic motor controlled by a hydraulic system of the tractor vehicle.

The blades attack the plants approximately according to the same angle in order to promote cutting of these plants.

Each rotor is provided with a braking means for emergency stopping of the rotor and entailing a brake disk rotationally connected to the rotor and a caliper with disk brake pads made of friction material connected to the casing.

The invention will be better understood and other aims, characteristics, details and advantages of it will appear more clearly in the course of the following explanatory description in reference to the appended drawings given only as examples relating to several embodiments of the invention and in which:

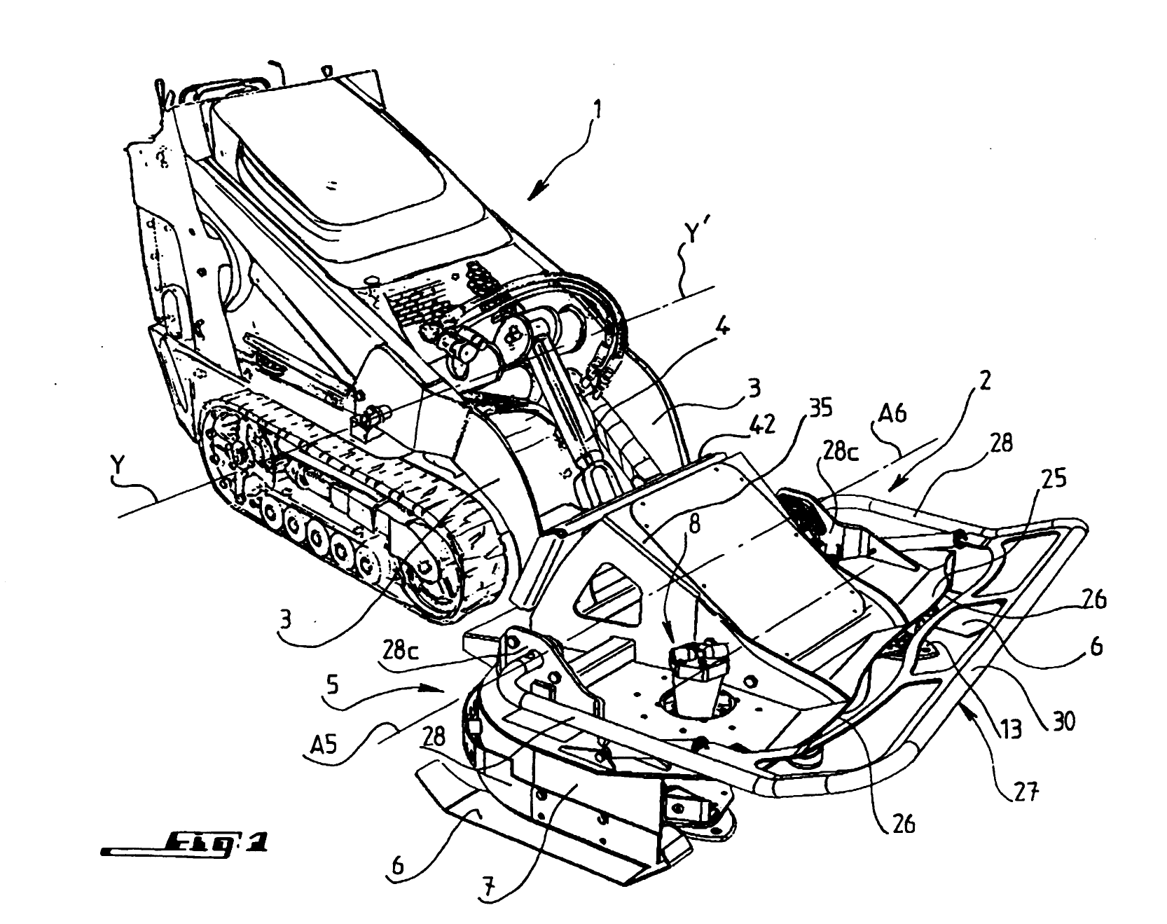

FIG. 1 is a view in perspective of the clearing-grinding device of the invention coupled to a tractor vehicle;

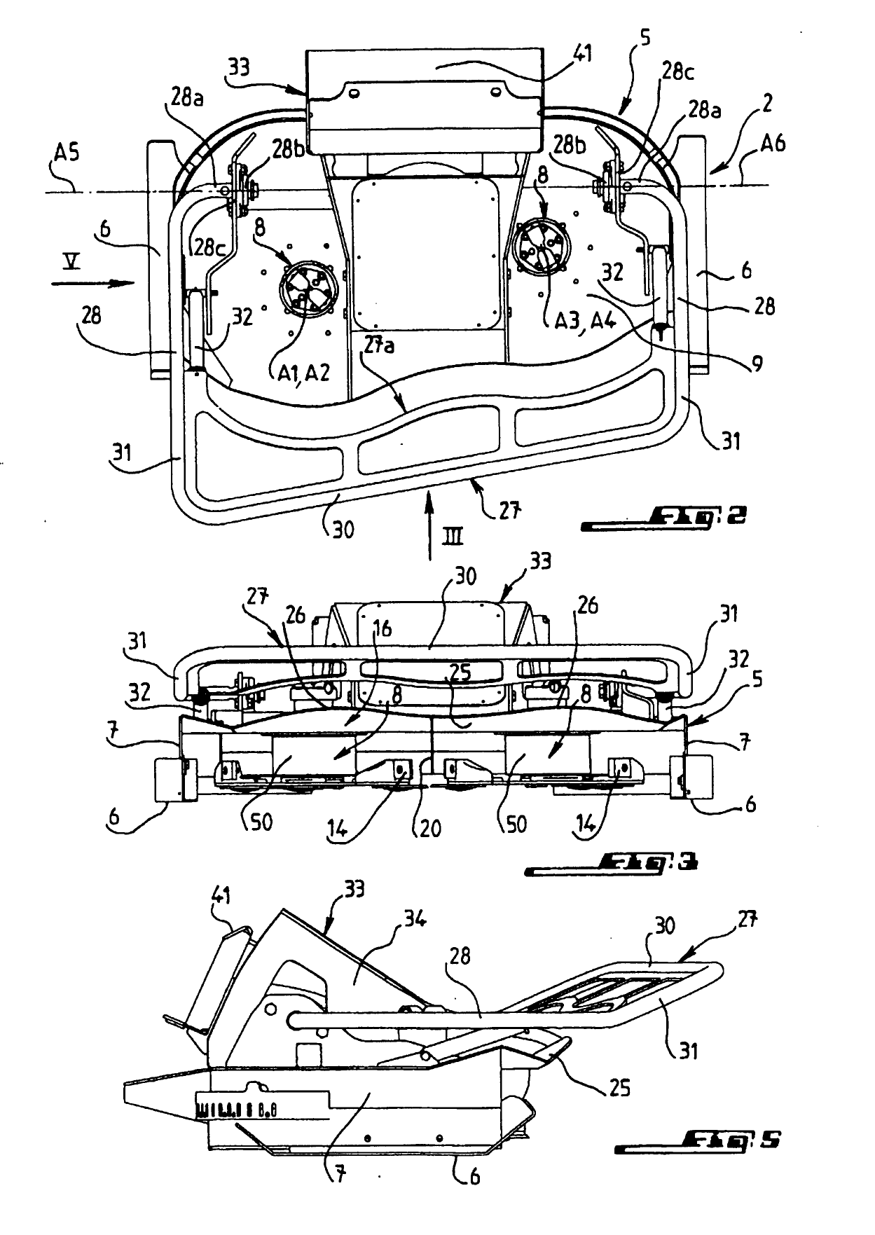

FIG. 2 is a top view of the clearing-grinding device;

FIG. 3 is a side view according to arrow III of FIG. 2;

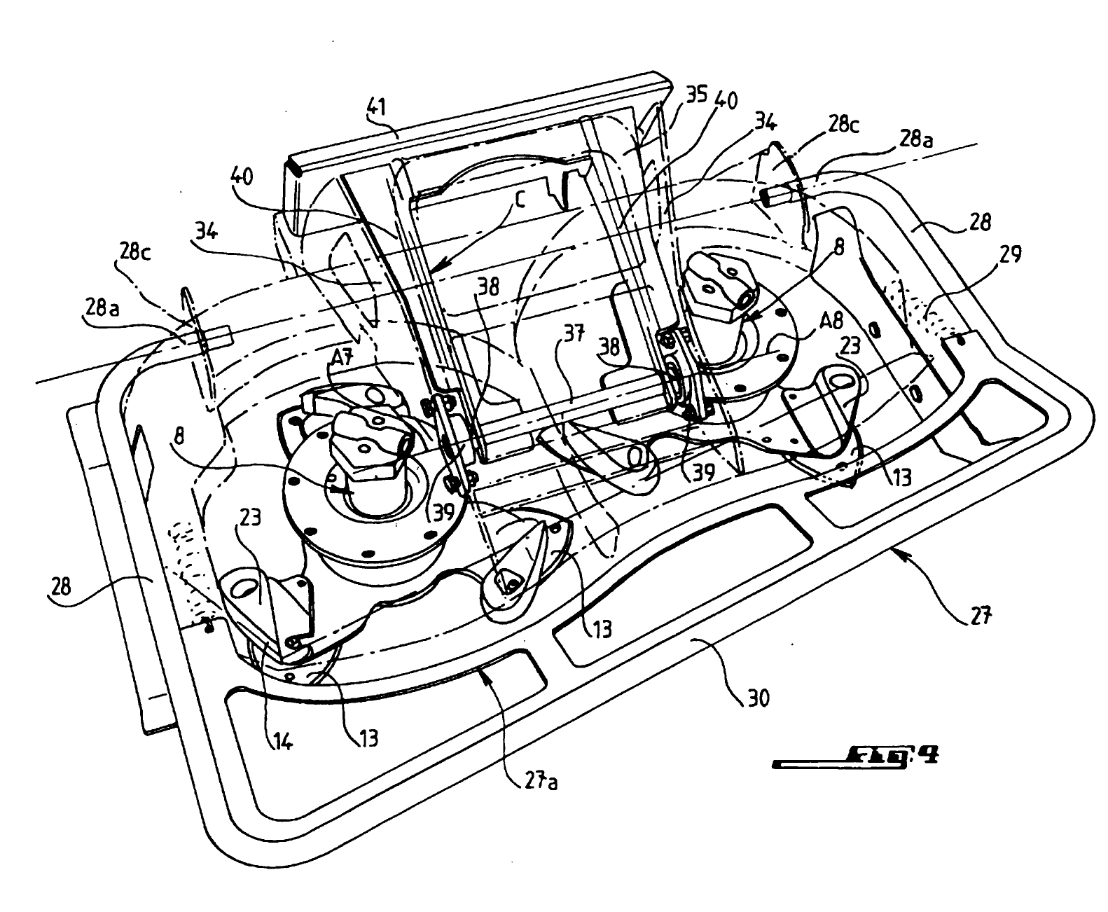

FIG. 4 is a top view in perspective of the clearing-grinding device showing by transparency the means making it possible to couple it to the tractor vehicle;

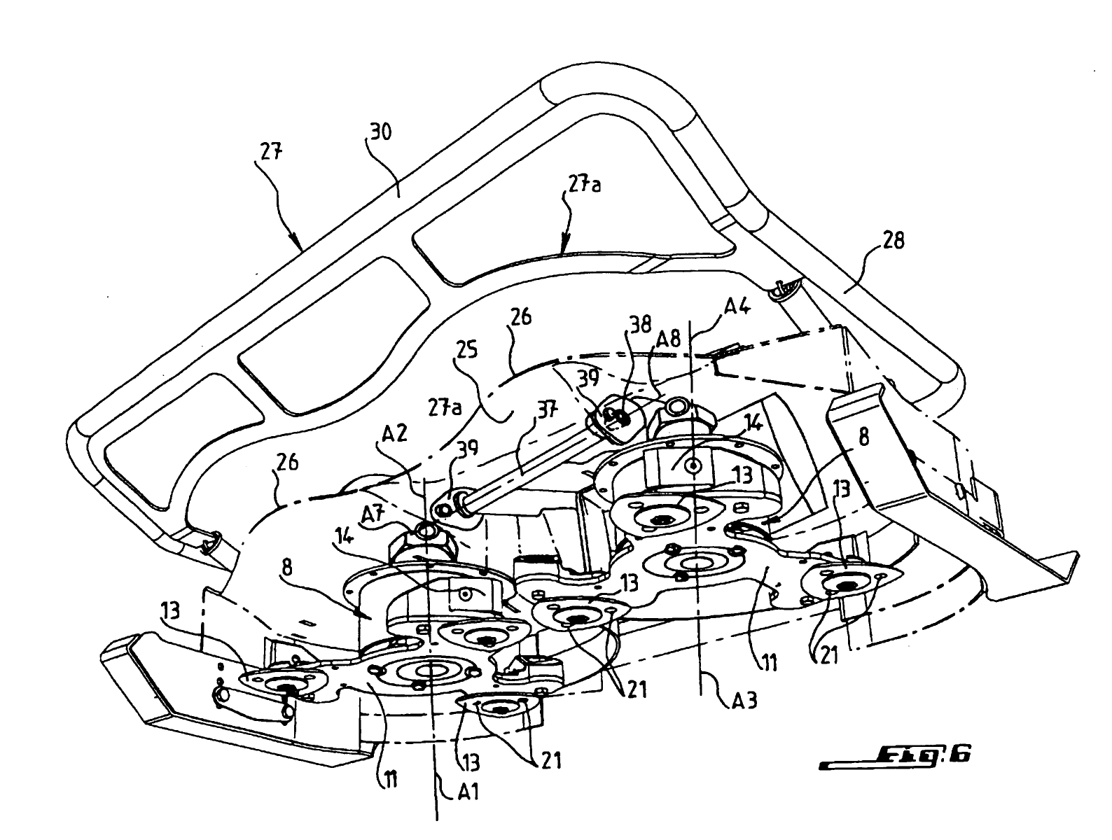

FIG. 5 is a side view according to arrow V of FIG. 2;

FIG. 6 is a view in perspective from below of the clearing-grinding device of the invention;

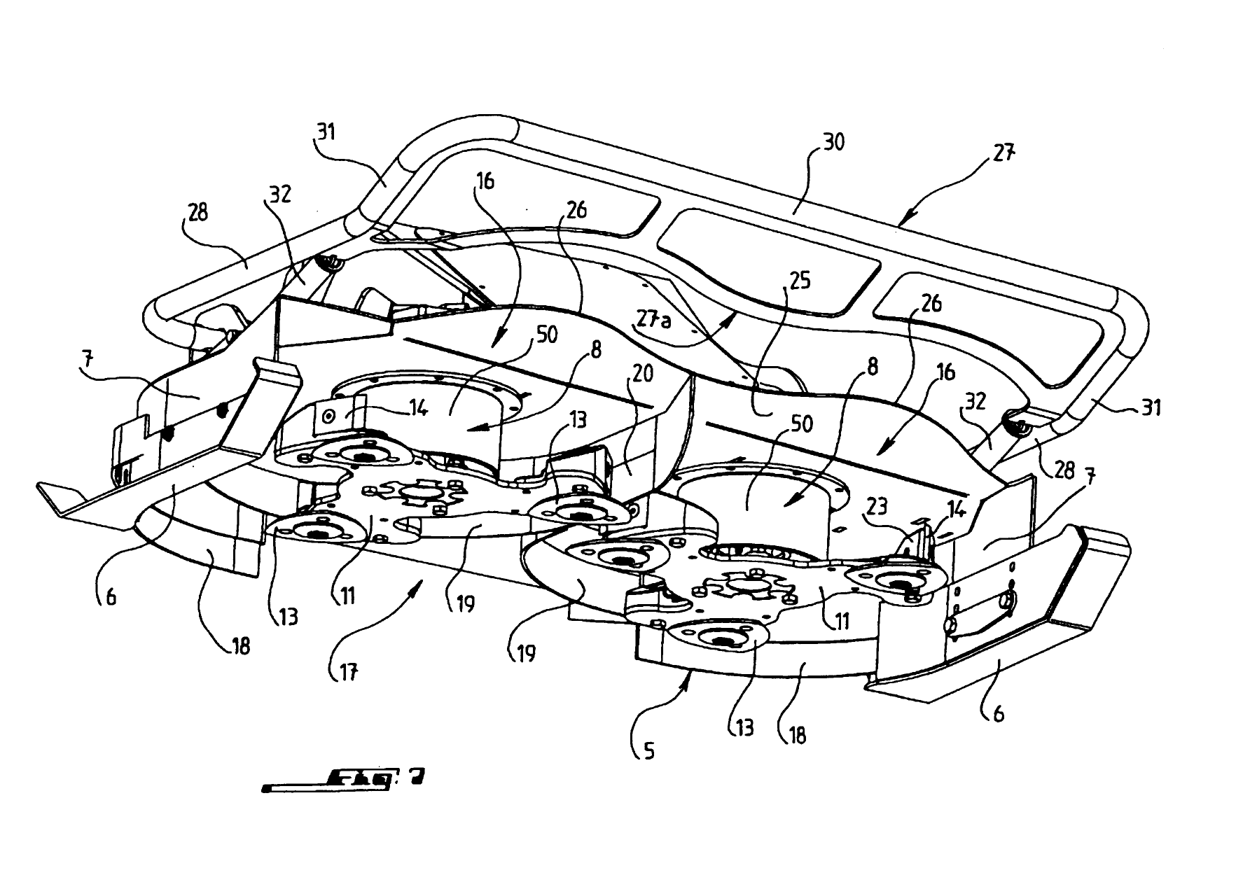

FIG. 7 is another view in perspective from below of the clearing-grinding device of the invention;

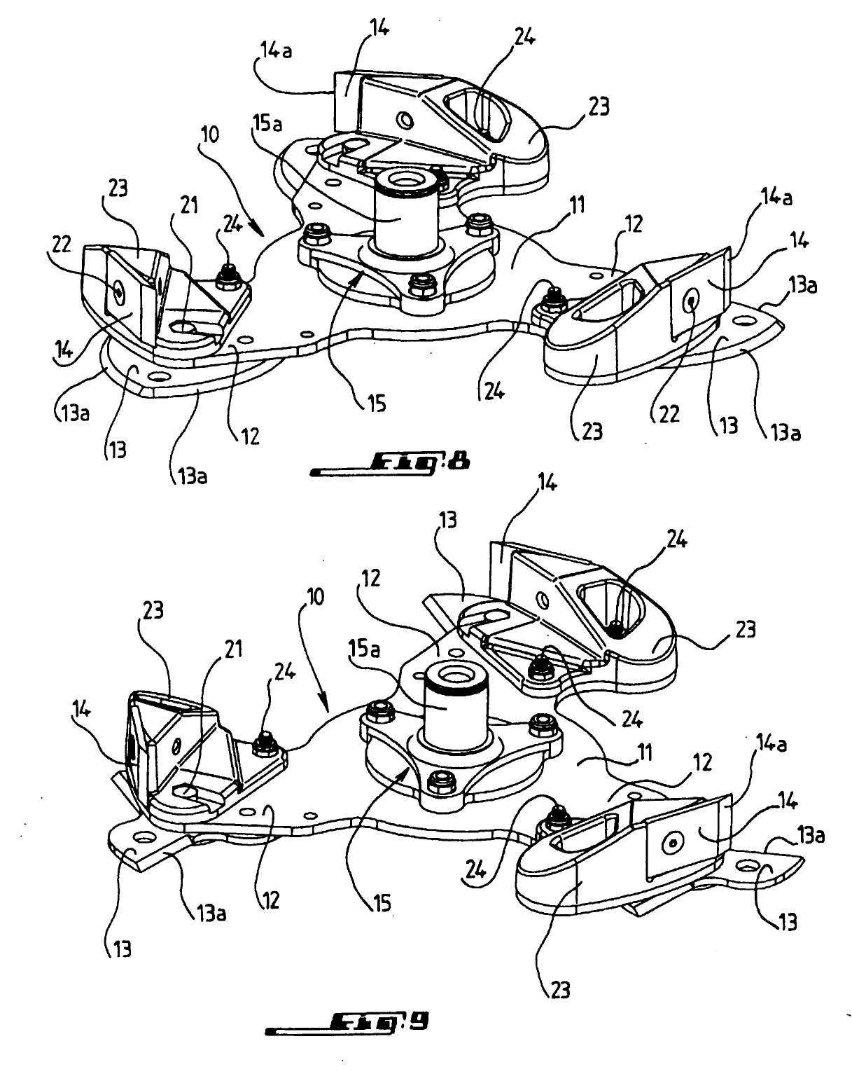

FIG. 8 is a view in perspective of a rotor of the device of the invention with horizontal and vertical blades according to a first embodiment;

FIG. 9 is a view in perspective of a second embodiment of a rotor with horizontal and vertical blades;

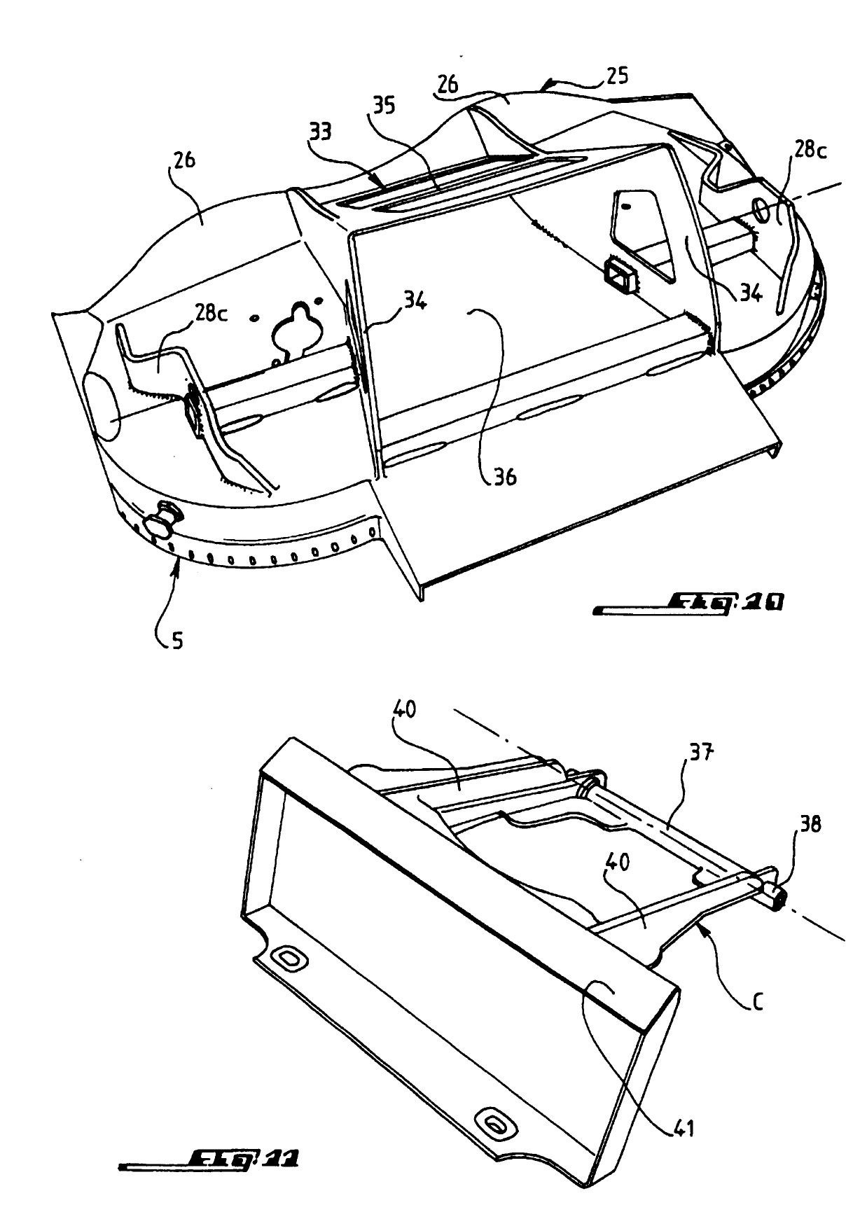

FIG. 10 is a rear view in perspective of the casing of the clearing-grinding device of the invention;

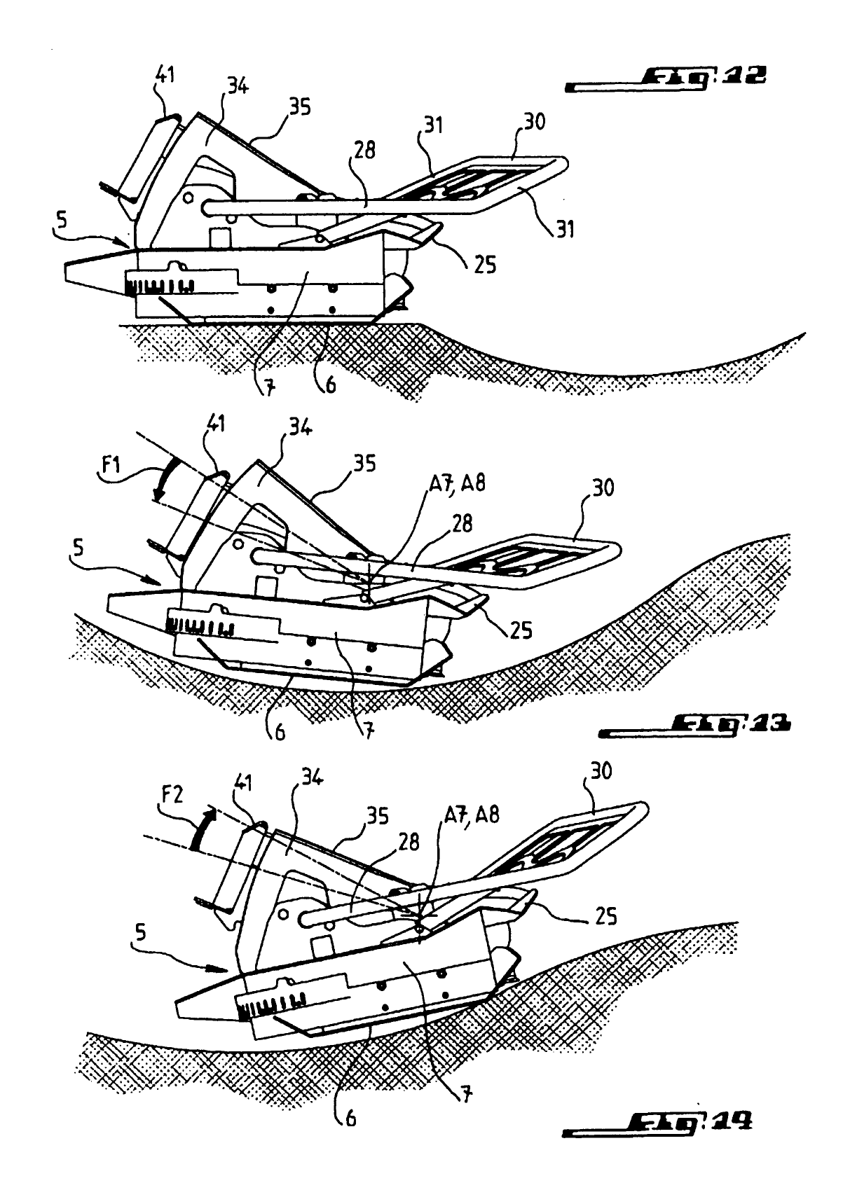

FIG. 11 is a rear view in perspective of the means making it possible to couple the clearing-grinding device of the invention to the tractor vehicle;

FIG. 12 represents the clearing-grinding device of the invention moving over flat ground;

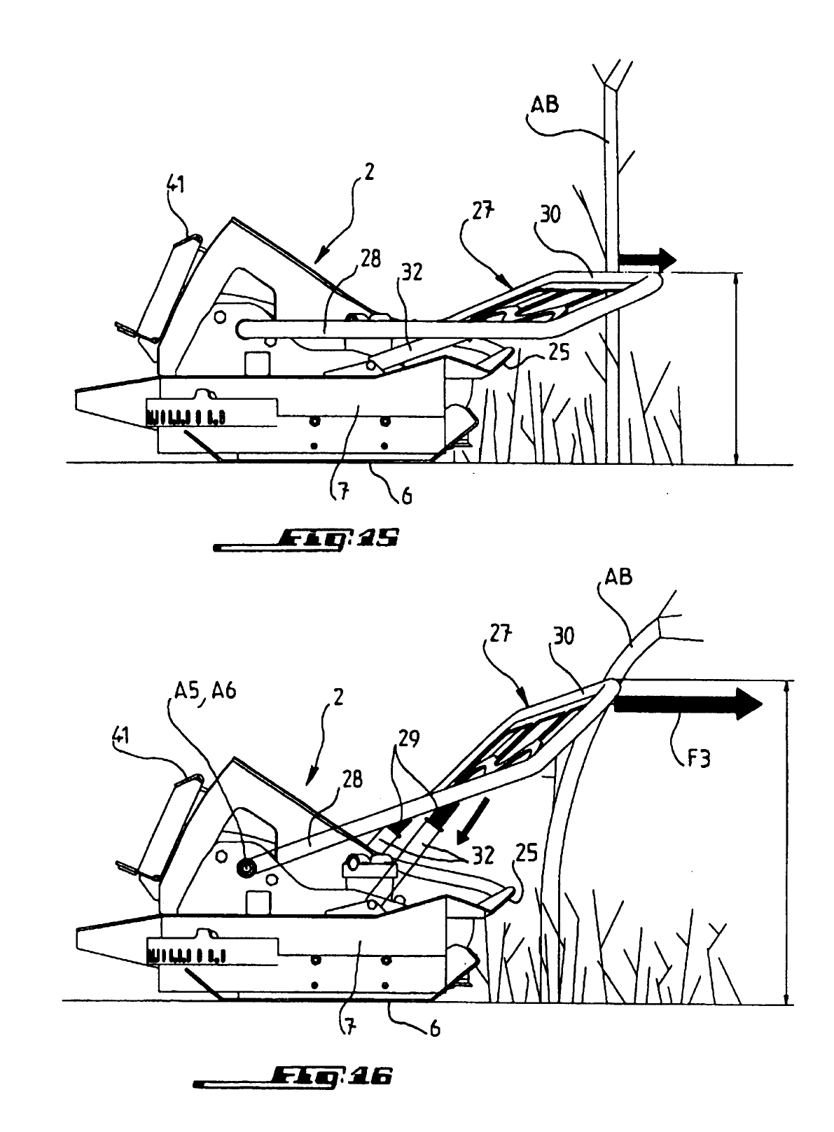

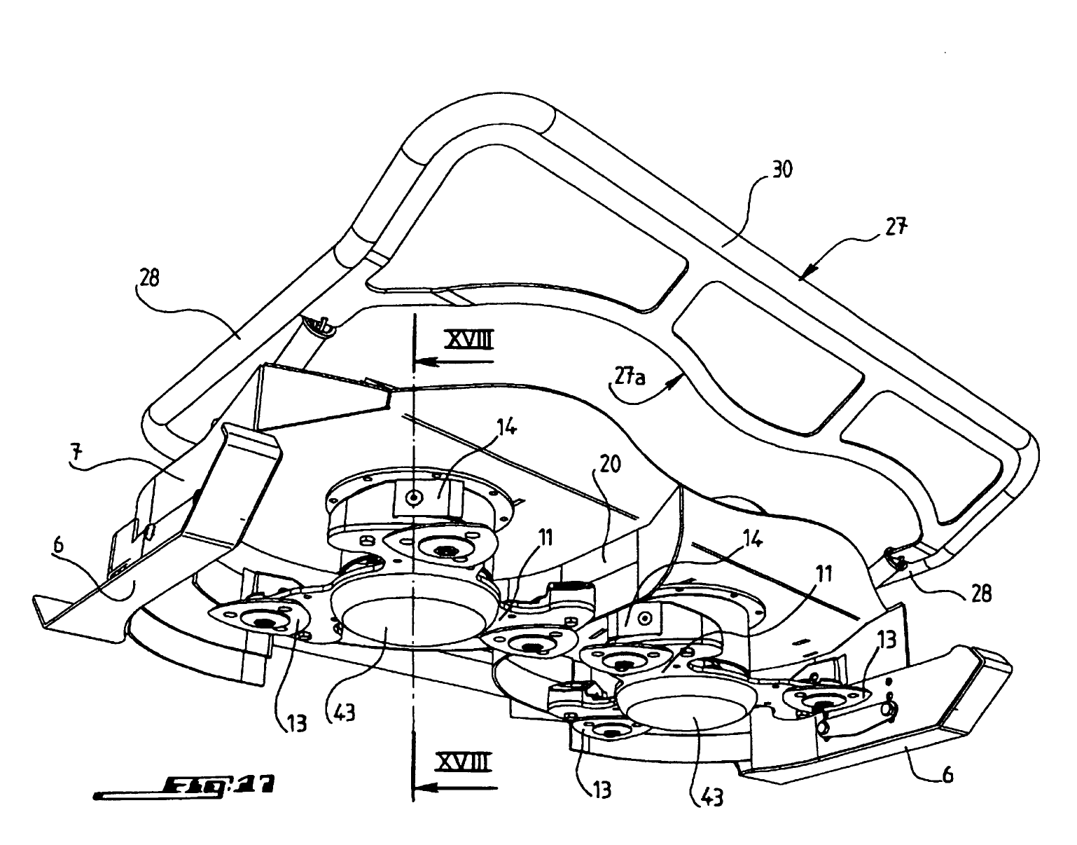

FIGS. 13 and 14 represent the clearing-grinding device of the invention moving on irregular ground;

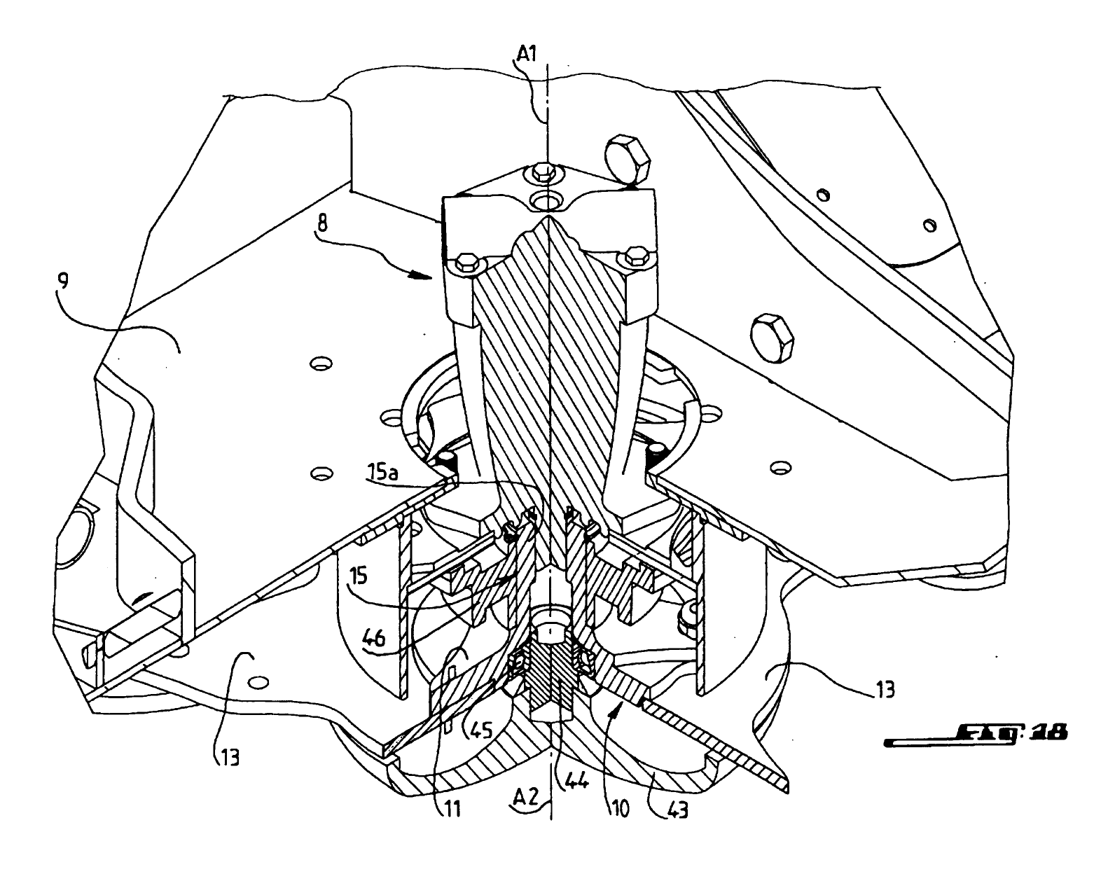

FIGS. 15 and 16 represent the pivoting of a bow of the clearing-grinding device of the invention, making it possible to exert a force for bending of the shrubs to be cut and ground;

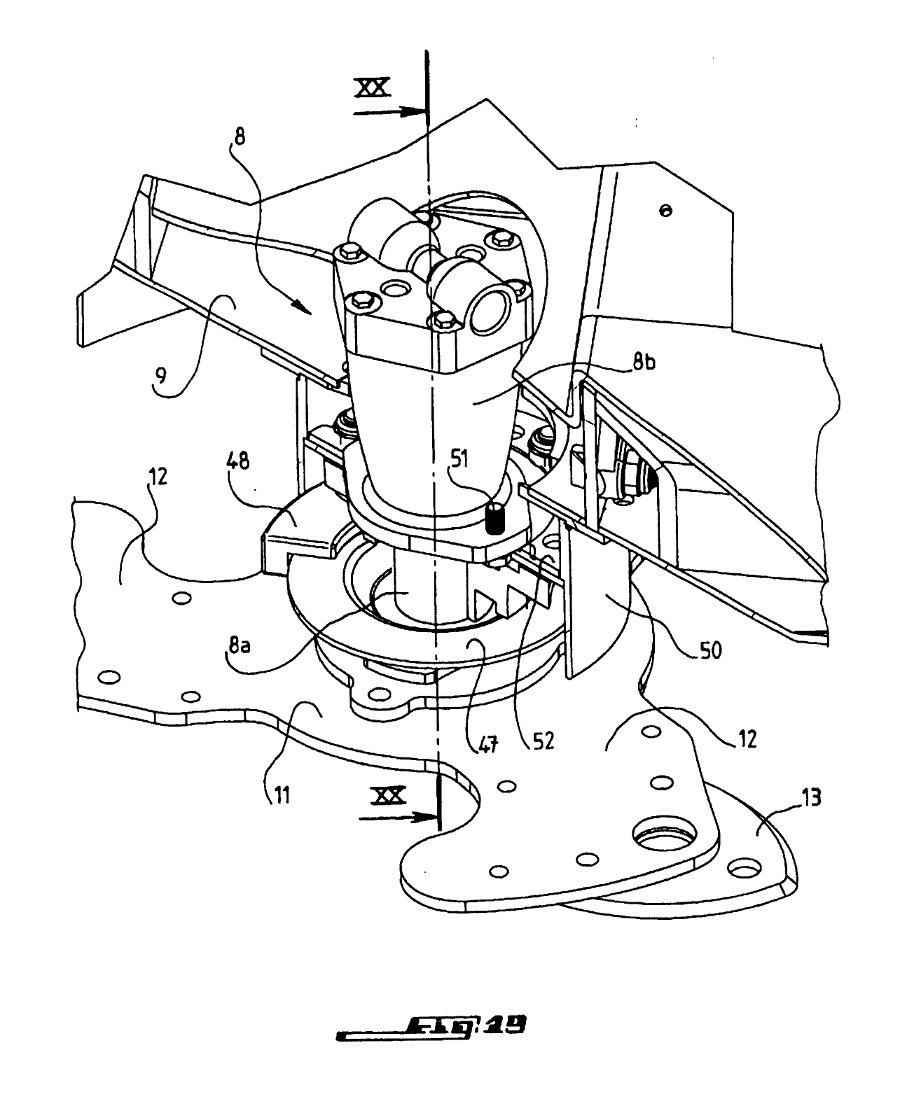

FIG. 17 is a view in perspective of an execution variant of a rotor of the grinding device of the invention;

FIG. 18 is a view in section according to line XVIII-XVIII of FIG. 17;

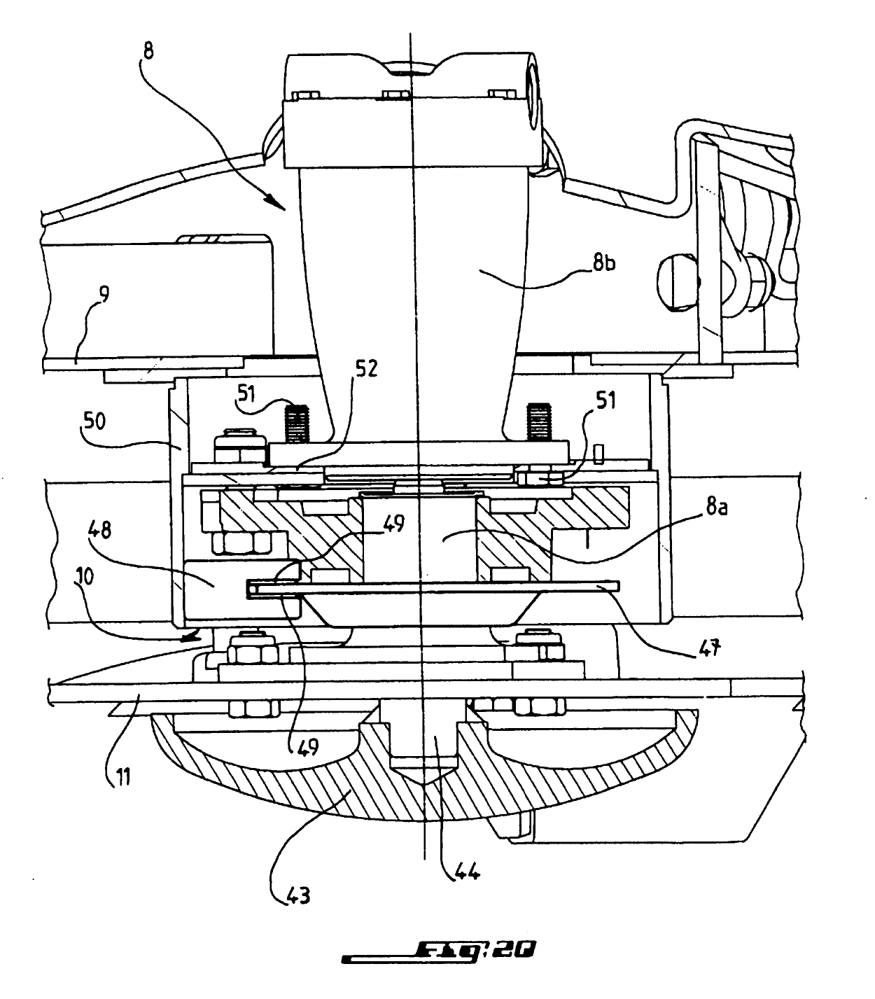

FIG. 19 is a view in perspective of another execution variant of a rotor of the grinding device of the invention; and

FIG. 20 is a view in section according to line XX-XX of FIG. 19.

FIG. 1 represents tractor vehicle 1 to whose front part device 2 of the invention is coupled, device which in particular makes it possible to grind plants.

Tractor vehicle 1, known in itself is of the type with driving tracks and is driven by a person situated behind the vehicle. The latter essentially has two lateral front arms 3 mounted so as to pivot on vehicle 1 around axis Y-Y′ which is transverse with respect to the direction of forward movement of the vehicle and whose opposite ends from the axis of pivoting are coupled to grinding device 2 in such a way as to lower the latter in work position on the ground or to lift it to an inactive raised position for transport. The lowering and raising movements of grinding device 2 can be controlled by central hydraulic jack 4 inserted between grinding device 2 and the body of tractor vehicle 1.

Grinding device 2 has casing 5 that is open underneath and that can rest on the ground by the intermediary of two lateral skids 6 attached respectively at the lower ends of two lateral walls 7 of casing 5. However, grinding device 2 can be moved over the ground by the intermediary of wheels instead of skids 6.

Casing 5 is provided with two motor means 8 such as hydraulic motors, for example, connected to upper wall 9 of casing 5 and these make possible the rotation around two vertical axes A1, A2 and A3, A4 respectively of two rotors 10 housed in casing 5, each provided with rotating blades on the periphery of the rotor.

Each rotor 10 has plate 11 and essentially radial arms 12, three of them in this case, whose ends carry cutting and grinding blades 13, 14. Each rotating plate 11 has central hub 15 coupled to the drive shaft of the corresponding motor 8.

Casing 5, in its front part, has opening 16 for entry of the plants to be cut and ground, and in its rear part, opening 17 for evacuation of the cut and ground plants. Evacuation opening 17 is delimited by two curved rear walls 18 projecting perpendicularly below upper wall 9 of casing 5 and respectively extending the two lateral walls 7 of the casing. Casing 5 also has, underneath it, curved partitions 19 connected perpendicularly to the internal surface of wall 9 and separating the two rotors 10 from one another as well as the parts of the two motors 8 projecting under casing 5. The two curved partitions 19 are joined together essentially in the longitudinal median plane of casing 5 by partition 20 extending essentially longitudinally with respect to the direction of forward movement of device 2 and thus delimiting entrance opening 16 into two parts allowing the plants to enter the zone of action of blades 13, 14 of one rotor 10 on one side or the zone of action of blades 13, 14 of the other rotor 10 on the other side.

Each rotor 10 has three horizontal flat blades 13, each attached in a removable manner by the intermediary of two fastening screws 21 under the corresponding support arm 12, and three vertical blades 14, each attached in a removable manner on the corresponding support arm above the associated horizontal blade 13.

As emerges more clearly from FIGS. 8 and 9, each vertical blade 14 is attached in a removable manner by the intermediary of screw 22 to a body forming ballast 23 that is itself attached in a removable manner on the corresponding support arm 12 by bolts 24. Thus, blades 13, 14 are ballasted in order to increase their inertia.

Blades 13, 14 have their sharp leading edges 13a, 14a oriented in the direction of rotation of rotor 10.

As represented in particular in FIGS. 6 and 8, each horizontal blade 13 has the general shape of an equilateral triangle of which the three sides are exteriorly convex or curved, respectively constituting three sharp leading edges 13a. When horizontal blade 13 is attached under the corresponding support arm 12, only one of the summits of this blade delimited between two leading edges 13a projects from this arm. In case leading edge 13a of horizontal blade 13 becomes worn, the latter can be removed from its support arm 12 and rotated around itself and re-attached under arm 12 in such a way that one of the other two summits of blade 13 projects from this arm. Thus, a new sharp leading edge 13a is used for cutting the plants.

FIG. 9 shows another embodiment of each horizontal blade 13 consisting of three plates with leading edges 13a spaced angularly 120° from one another. As in the case of each blade of FIG. 8, blade 13 of FIG. 9 can be removed from its support arm 12 so as to replace a worn leading edge branch 13a by one of the other two leading edge branches 13a projecting from this arm.

Vertical axes A1, A2 and A3, A4 respectively of the two rotors 10 are a distance from one another in the transverse direction with respect to the direction of forward movement of device 2 such that the zones of action of their respective horizontal blades 13 and vertical blades 14 overlap, horizontal blades 13 preferably being situated in the same cutting plane and turning below the lower edges of partitions 19, 20. In this way, the plants passing between the blades of two rotors 10 are systematically cut and ground. Furthermore, vertical axes A1, A2 and A3, A4 of the two rotors 10 are offset with respect to one another according to the direction of forward movement of grinding device 2.

Casing 5, at its front part, has fixed rigid external deflector 25 inclined upward above entrance opening 16 for the plants and extending according to the transverse direction of forward movement of grinding device 2. Deflector 25, during the forward movement of grinding device 2, thus makes it possible to exert on the low parts of the plants a bending force in order to facilitate penetration of the plants into entrance opening 16 of casing 5 and their cutting and grinding by blades 13, 14. Furthermore, the front edge of deflector 25 has two curved parts 26 that are separate in the transverse direction with respect to the direction of movement of grinding device 2 and whose radii, considering the projection of the two curved parts 26 on a horizontal plane, are centered respectively on the two vertical axes A1, A2 and A3, A4 of rotors 10 so that the plants contacting each curved part 26 can penetrate into the zone of action of blades 13, 14 of the corresponding rotor 10 and be cut and ground by these blades.

Grinding device 1 also has rigid bow 27 of which the two parallel arms 28 are mounted so as to pivot on casing 5 according to axis A5, A6 that is transverse with respect to the direction of movement of device 2 in opposition to the elastic force exerted by means 29 returning bow 27 to a lowered position in which the two arms 28 are essentially horizontal. Central bar 30 of bow 27 is connected to the opposite ends of arms 28 from axis of pivoting A5, A6 by the intermediary of another two shorter arms 31 extending arms 28 and inclined upward with respect to a horizontal plane. Central bar 30 can extend obliquely or transversely with respect to the direction of forward movement of device 2.

Preferably, the two means for returning bow 27 to its lowered position consist respectively of two helical draw springs 29 arranged parallel to arms 28 near them. Each spring 29 has one of its end turns attached to upper wall 9 of casing 5 and its opposite end turn attached to the corresponding arm 28. A network of stiffening ribs 27a is provided in the space between front central bar 30 and the two extension arms 31.

Transverse ends 28a of the two arms 28 are mounted so as to pivot in two bearings 28b connected respectively to two rigid plates 28c forming flanges that are themselves connected to upper wall 9 of casing 5.

Bow 27 is intended to rest, by its central bar 30, on high shrub parts during movement of grinder 2 so as to bring about the raising of bow 27 in opposition to the return force of draw springs 29 that exert a bending force on each shrub before these shrubs are contacted by deflector 25 and then ground by blades 13, 14 in casing 5.

Each spring 29 can be housed in protective sheathe 32.

As emerges more clearly from FIG. 10, casing 5 also has part 33 approximately in the form of a recumbent truncated pyramid, that is to say extending according to the longitudinal direction of casing 5 parallel to the direction of forward movement of device 2, and whose large base is open on the opposite side from entrance opening 16 for the plants. Part 33 is thus defined by two essentially parallel lateral walls 34 connected to upper wall 9 of casing 5 perpendicularly to it and two upper 35 and lower 36 walls, with it possible for interior [sic; lower] wall 36 to consist quite simply of the corresponding wall part of wall 9 of casing 5. Upper wall 35 is inclined relative to lower wall 36 of part 33, preferably by an angle of approximately 10°. Part 33 can be attached on casing 5 by welding.

Part C in the form of a rigid frame of general rectangular shape is housed in truncated pyramid shaped part 33 of casing 5 in such a way that the front side of frame C consists of shaft 37 whose two opposite ends are mounted so as to rotate respectively in two bearings 39 respectively attached to the internal surfaces of the two lateral walls 34 of truncated pyramid shaped part 33.

The two parallel sides or longitudinal members 40 of frame C perpendicular to shaft 37 are connected to rear bracket 41 of the frame and in which rigid plate 42 can be set in a removable manner, plate that is connected to the ends of the two lifting arms 3 transversely with respect to them. The rod of lifting jack 4 is articulated to rigid plate 42.

In this way, the assembly consisting of frame C and base 41 is connected to lifting arms 3 of tractor vehicle 1, and casing 5 can pivot relative to frame 6 around transverse axis A7, A8 extending coaxially with respect to shaft 37 of frame C in such a way as to allow grinding device 2 to follow the irregularities of the ground over which it is moving.

The angular clearance of casing 5 around pivoting axis A7, A8 is limited by the two upper and lower walls 35 and 36 of part 33, and preferably, this clearance is at most an angle of approximately 10°.

When motor means 8 for the two rotors consist of hydraulic motors, these are controlled, along with hydraulic jack 4, by the hydraulic system of tractor vehicle 1.

The functioning of grinding device 2 of the invention already emerges from the preceding description and will now be explained in connection with FIGS. 12 to 16 that do not present tractor vehicle 1 for moving device 2.

When device 2 moves forward over irregular ground as represented in FIGS. 13 and 14, it can pivot around axis A7, A8 relative to frame 6 and consequently to the lifting device of the tractor device in the direction indicated by arrow F1 or F2 depending on the irregularities of the ground over which device 2 is moving.

When device 2 presents itself in front of shrub AB, central bar 30 of bow 27 rests on a relatively high part of shrub AB, and by continuing the movement of device 2, bow 27 is raised by shrub AB in opposition to the return force of the two springs 29 that then exert on bow 27 and consequently on shrub AB a force that is proportional to the resistance of the shrub to be cut so as to bend it before deflector 25 comes in contact with the low part of shrub AB. Thus, bow 27 makes it possible to assist grinding device 2 with the preliminary bending of shrub AB before it is also bent in the low part by deflector 25, which makes it possible to facilitate penetration of shrub AB into the zone of action of blades 13, 14 of rotors 10 and to cut and grind it more effectively.

FIGS. 17 and 18 represent an execution variant according to which overturned cup 43 is attached under plate 11 and horizontal blades 13 connected to plate 11 while being mounted so as to rotate freely at rotating plate 11 coaxially with respect to vertical axis A1, A2 or A3, A4 of rotor 10. Thus, each cup 43 has central hub 44 extending coaxially with respect to the vertical axis of rotation of rotor 10 and mounted so as to rotate in rotating plate 11 preferably by the intermediary of bearing 45, for example, of the ball bearing type. FIG. 18 also shows that shaft 15a of hub 15 of rotating plate 11 is mounted so as to rotate around vertical axis A1, A2 or A3, A4 relative to casing 5 by the intermediary of bearing surface 46 connected to this casing. Of course, hydraulic motor 8 associated with rotating plate 11 drives the latter in a conventional manner.

Each cup 43 can thus turn freely, relative to the corresponding plate 11, and makes it possible to provide protection for horizontal blades 13 because of a ground clearance of each cup. In effect, if, during movement of grinding device 2, the blades should come dangerously close to the ground, each associated cup 43 contacts the ground before horizontal blades 13 while being immobilized on the ground but without preventing the rotation of the plate and blades 13, 14. The ground clearance of each cup 43 is of course greater than the ground clearance of casing 5 of grinding device 2.

FIGS. 19 and 20 represent an execution variant of FIGS. 17 and 18 according to which rotor 10 is moreover provided with a means of braking with brake disk 47 rotationally connected to shaft 8a of motor 8 and that is of course rotationally connected to plate 11 for support of blades 13, 14, and brake caliper 48 provided with friction linings 49 situated on either side of brake disk 47. Caliper 48 is connected to a corresponding internal surface of cylindrical support 50, connected to casing 5, enclosing and protecting rotor 8a and brake disk 47. Casing 8b of motor 8 is attached by the intermediary of fastening screws 51 to support wall 52 that is attached in support cylinder 50 transversely with respect to the latter. Brake caliper 48 is hydraulically controlled so as to brake disk 47 in case of emergency stopping of rotor 10.

1. A plant clearing-grinding device comprising:
a casing that is open underneath and can be coupled to a tractor vehicle; and
two motorized rotors mounted to rotate around two vertical axes under the casing and having respective plates including cutting and grinding blades, wherein
the casing has, at a front part, an entrance opening for entry of plants to be cut and ground and, at a rear part, an exit opening for evacuation of cut and ground plants,
the front part of the casing has a fixed external deflector inclined upward above the entrance opening for bending plants during movement of the device to facilitate penetration of the plants into the entrance opening, and
the deflector has a front edge with two separate curved parts transverse to direction of movement of the device and having radii respectively centered on the two vertical axes of rotation of the two rotors so that plants contacting each curved part can penetrate into a zone of action of the blades of one of the rotors.

2. The device according to claim 1, including a rigid bow having arms pivotally mounted on the casing and pivoting about respective axes that are transverse to the direction of movement of the device;
elastic means biasing the bow to a lowered position; and
a central bar resting, during movement of the device, on parts of plants raised in opposition to the biasing of the elastic means and bending plants before contacted by the deflector to facilitate entry of the plants into the zone of action of the blades.

3. The device according to claim 2, wherein the elastic means includes two helical draw springs, each draw spring being attached between the casing and a corresponding arm of the bow.

4. The device according to claim 3, wherein each draw spring is housed in a protective sheath.

5. The device according to claim 1, wherein the blades of each rotor are removably attached to ends of essentially radial support arms of a corresponding plate and include horizontal flat blades respectively attached under the support arms.

6. The device according to claim 5, wherein the blades include vertical blades respectively attached to the radial support arms.

7. The device according to claim 5, wherein the radial support arms include a ballast at ends of the radial support arms.

8. The device according to claim 7, wherein each vertical blade is attached to a corresponding ballast.

9. The device according to claim 5, wherein each horizontal blade has an equilateral triangle shape and sharp exterior convex sides and is attached to the end of the corresponding radial support arm so that only one summit of three summits of each blade delimited by two sharp sides projects from each radial support arm.

10. The device according to claim 9, wherein each horizontal blade can be disconnected from a radial support arm and re-attached to the radial support arm so that another of the other two summits of the blade projects from the radial support arm.

11. The device according to claim 5, wherein the horizontal blades of the two rotors are situated in the same cutting plane.

12. The device according to claim 5, wherein the vertical axes of the two rotors are spaced apart from one another, transversely, so the zones of action of respective horizontal and vertical blades overlap.

13. The device according to claim 1, wherein the casing is coupled to the tractor vehicle so that the casing can pivot according to a limited angle around a horizontal axis that is transverse to the direction of forward movement of the vehicle, in response to irregularities of the ground.

14. The device according to claim 13, including a rigid frame coupling the casing to the tractor vehicle, the rigid frame being removably attached to one side of a lifting structure of the tractor vehicle and attached on an opposite side to two vertical walls of the casing, forming a support flange journaled to the ends of a shaft of the frame, extending transverse to the direction of forward movement of the tractor vehicle.

15. The device according to claim 14, wherein the frame is attached to a plate of the lifting structure of the tractor vehicle and removably attached to a bracket connected to the frame.

16. The device according to claim 14, wherein the frame is housed in a recumbent part that is approximately a truncated pyramid of the casing, two upper and lower walls of the recumbent part being inclined with respect to one another to delimit between them an angular clearance of the casing, relative to the frame, around the horizontal axis of pivoting of the casing.

17. The device according to claim 13, wherein the angle of pivoting of the casing is approximately 10°.

18. The device according to claim 1, wherein the vertical axes of the two rotors are offset with respect to one another according to the direction of movement of the device.

19. The device according to claim 1, wherein the casing includes skids connected to lateral walls of the casing.

20. The device according to claim 1, including a protective overturned cup attached under the plate of each rotor and below the blades of the respective plate while being free to rotate coaxially with respect to the vertical axes of the rotors.

21. The device according to claim 1, including a hydraulic motor directly driving each rotor and controlled by a hydraulic system of the tractor vehicle.

22. The device according to claim 1, wherein the blades attack plants at approximately the same angle to promote cutting of the plants.

23. The device according to claim 1, wherein each rotor includes braking means for emergency stopping of the rotor and including a brake disk rotationally connected to the rotor and a caliper with disk brake pads connected to the casing.
